(19) United States
(12) Patent Application Publication
(10) Pub. No.: US 2006/0072676 A1
(43) Pub. Date: Apr. 6, 2006

(54) Defining interpolation filters for error concealment in a coded image

(76) Inventor: Cristina Gomila, Princeton, NJ (US)

Correspondence Address: THOMSON LICENSING INC., PATENT OPERATIONS, PO BOX 5312, PRINCETON, NJ, 08543-5312, US

(21) Appl. No.: 10/541,929

(22) PCT Filed: Jul. 10, 2003
(86) PCT No.: PCT/US03/21515

§ 371 Date: Jul. 11, 2005

Related U.S. Application Data
(60) Provisional application No. 60/439,185, filed on Jan. 10, 2003.

(51) Int. Cl. H04B 1/66; H04N 11/04; H04N 7/12; H04N 11/02

(52) U.S. Cl. 375/240.27; 375/240.24

(57) ABSTRACT

Concealment of errors in a coded image occurs by first selecting an inter-prediction mode in accordance with the coding of the image. The selected intra-prediction mode, while ordinarily used to specify the direction for obtaining a coding prediction value, also serves to specify the direction for obtaining estimated values for error concealment. An interpolation filter defines the manner of obtaining estimated pixel values along the direction specified by the intra-prediction mode. Like the intra-prediction mode, the interpolation filter is derived in accordance with the coding of the image. Concealment of the image is achieved using the estimated values obtained in the manner prescribed by the interpolation filter.

### CROSS REFERENCE TO RELATED APPLICATION

This application claims priority under 35 U.S.C. 119(e) to U.S. Provisional Patent Application Ser. No. 60/439,185 filed Jan. 10, 2003, the teachings of which are incorporated herein.

### TECHNICAL FIELD

This invention relates to a technique for defining directional interpolation filters for the concealment of errors within a coded video stream.

### BACKGROUND ART

In many instances, video streams undergo compression (coding) to facilitate storage and transmission. Presently, there exist a variety of coding schemes, including block-based coding schemes such as the proposed ISO/ITU H.2.64 coding technique. Not infrequently, such coded video streams incur data losses or become corrupted during transmission because of channel errors and/or network congestion. Upon decoding, the loss/corruption of data manifests itself as missing/corrupted pixel values that give rise to image artifacts. To reduce such artifacts, a decoder will “conceal” such missing/corrupted pixel values by estimating such values from other macroblocks in the same image or from other images. The term conceal is a somewhat of a misnomer because the decoder does not actually hide missing/corrupted pixel values.

Spatial concealment seeks to derive the missing/corrupted pixel values by using pixel values from other areas in the same image relying on the similarity between neighboring regions in the spatial domain. Typically, at the same level of complexity, spatial concealment techniques achieve lower performance than temporal error concealment techniques that rely on information from other transmitted pictures. An error concealment algorithm should invoke spatial interpolation only in those instances where no temporal option is available, that is, when losses affect intra-coded pictures, intra refresh pictures or when no temporal information is available. The quality of future inter-coded frames that use a concealed image as a reference will depend on the quality of the spatial concealment. When the spatial concealment yields a relatively poor intra-coded picture, each resultant inter-coded picture will likewise have poor quality.

Various techniques exist for accomplishing spatial error concealment. These techniques include: (a) Block copy (BC), (b) Pixel Domain Interpolation (PDI), (c) Multi-directional Interpolation (MDI), (d) Maximally Smooth Recovery (MSR) and (e) Projection On Convex Sets (POCS). Moreover, there now exists a proposal to make use of the intra-prediction modes computed for blocks of 4×4 pixels in accordance with the H.264 technique for error concealment. In accordance with this proposal, the same intra-prediction modes that provide a direction for estimating the coding value from neighboring blocks can also provide a direction for estimating missing/corrupted pixels values for error concealment. Having established the desirability of using the same intra-prediction mode to provide the direction for error concealment as coding prediction, there exists a need to define an appropriate mechanism to derive estimated pixel values for concealment when proceeding in the direction defined by the intra-prediction mode.

### BRIEF SUMMARY OF THE INVENTION

Briefly, in accordance with the present principles, concealment of errors in a coded image comprised of an array of macroblocks commences by first identifying macroblocks within the image having missing/corrupted pixel values. For each identified macroblock, at least one intra-prediction mode is derived from neighboring macroblocks. When the image is coded in accordance with the ISO/ITU H.264 coding technique, intra-coded coded macroblocks can be predicted for coding purposes either as a whole block of 16×16 pixels, or on blocks of 4×4 pixels. For a whole 16×16 block, there exists one intra-prediction mode. In contrast, an intra-prediction mode exists for each sub-macroblock of 4×4 pixels within the macroblock. In connection with the derived intra-prediction mode, an interpolation filter is selected to define the manner in which pixel values are estimated from neighboring blocks selected by proceeding in a direction prescribed by the identified intra-prediction mode. The macroblocks having missing/corrupted pixel vales are concealed using the estimated pixel values obtained in accordance with the selected interpolation filter. When the macroblocks in the coded image are coded in accordance with the H.264 coding technique and the concealment order is equal to the decoding order, the interpolation filter established for concealment purposes constitutes the filter prescribed in the H.264 coding technique for the intra 4×4 prediction mode. Since different orders of concealment can exist, a mirrored version of the interpolation filters defined in the H.264 coding technique serves to adapt to available samples when neighboring left and above pixels are unavailable.

### BRIEF SUMMARY OF THE DRAWINGS

FIG. 1 depicts a coded picture partitioned into macroblocks, with each macroblock partitioned into blocks, and each block partitioned into pixels;

FIG. 2 illustrates the Intra_{—}4×4 prediction modes described in the proposed H.264 coding technique;

FIGS. 3A-3F each depict the position of the sets of reference pixels (A, B, C, D and I, J, K, L) as defined for the interpolation filters corresponding to the Intra_{—}4×4 prediction modes illustrated in FIG. 2; and

FIGS. 4A-4F each depict the position of the sets of reference pixels (A′,B′,C′,D′ and I′, J′, K′, L′) as defined for a first set of mirrored interpolation filters corresponding to the Intra_{—}4×4 prediction modes illustrated in FIG. 2.

FIGS. 5C-5F each depict the position of the sets of reference pixels (A′, B′, C′, D′ and I′, J′, K′, L′) as defined for a second set of mirrored interpolation filters corresponding to the Intra_{—}4×4 prediction modes illustrated in FIG. 2.

FIG. 6C depicts the position of the sets of reference pixels (A′, B′, C′, D′ and I′, J′, K′, L′) as defined for a third set of mirrored interpolation filters corresponding to the Intra_{—}4×4 prediction modes illustrated in FIG. 2.

### DETAILED DESCRIPTION

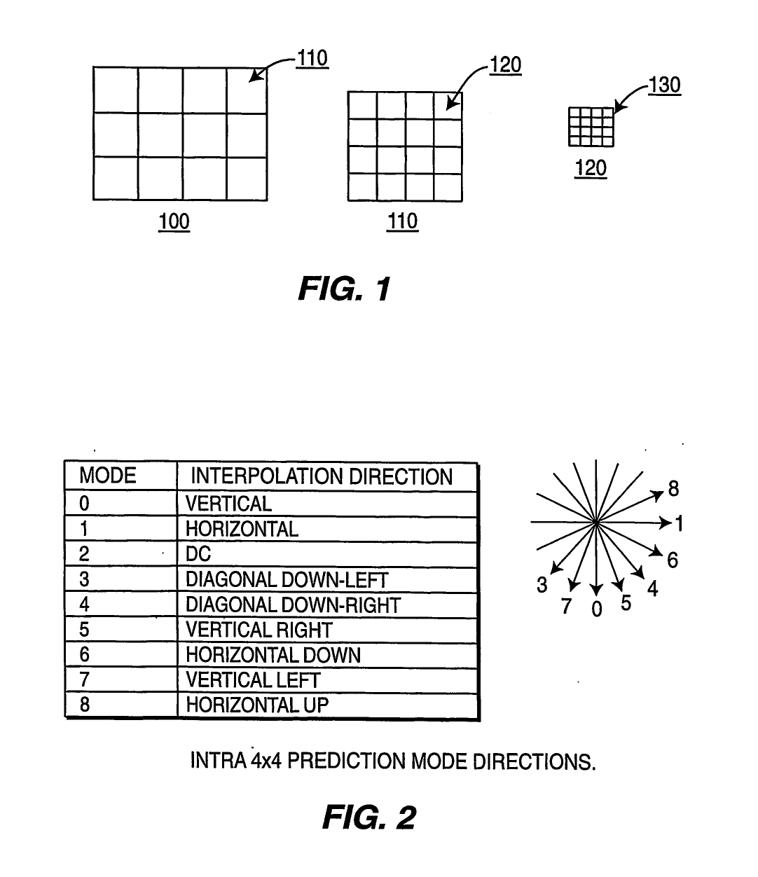

Block-based video compression techniques, such as embodied in the proposed ISO/ITU H.264 coding technique, operate by dividing a picture into slices, each slice comprising a set of macroblocks or macroblock pairs, with each macroblock coded in accordance with the coding technique. A macroblocks typically comprises a squared region of 16×16 pixels. For coding purposes, macroblocks can be further partitioned into sub-macroblocks not necessarily squared. Each sub-macroblock can have a different coding mode when the macroblock is encoded. For ease of discussion, a block will be referred to as a sub-macroblock of 4×4 pixels. FIG. 1 depicts the partitioning of a coded picture 100 into macroblocks 110, with each macroblock 110 partitioned into blocks 120, and each block partitioned into pixels 130. Note that the number of macroblocks within a picture varies depending on the size of the picture, while the number of blocks within a macroblock remains constant.

To reduce the cost of individually coding each macroblock 110 within the partitioned image 100, information from already transmitted macroblocks can s yield a prediction of the coding of an individual macroblock. In this case, only the prediction error and the prediction mode require transmission. The video coding technique employed to code the picture 100 will specify the process for deriving the predicted pixel values in order to ensure that the encoder (not shown) and the decoder (not shown) both obtain the same estimation. In accordance with the ISO/ITU H.264 coding technique, individual macroblocks can be intra-predicted either as a single partition of 16×16 pixels (Intra_{—}16×16 type coding) or as a partition of 16 blocks of 4×4 pixels (Intra_{—}4×4 type coding).

For the Intra_{—}16×16 type coding, the ISO/ITU H.264 coding technique specifies four intra-prediction modes: Mode 0, vertical prediction; Mode 1, horizontal prediction; Mode 2, DC prediction; Mode 3, plane prediction. For the Intra_{—}4×4 coding type, the ISO/ITU H.264 coding technique specifies nine intra-prediction modes: Mode 0, vertical prediction; Mode 1, horizontal prediction; Mode 2, DC prediction; Mode 3, diagonal down-left prediction; Mode 4, diagonal down-right prediction; Mode 5, vertical right prediction; Mode 6, horizontal down prediction; Mode 7, vertical left prediction; and Mode 8, horizontal up prediction. FIG. 2 depicts each of the Intra_{—}4×4 coding type prediction modes in tabular form as well as a vector display that indicates the direction of each of the intra-prediction Modes 0-8. (Note that Mode 2, corresponding to the DC mode, has no direction, since it uniformly predicts the content of a block within a homogeneous region.) The other modes 0-1 and 3-8 predict the content of a macroblock along a separate one of the eight quantized directions.

The proposed H.264 coding technique provides that each intra-prediction mode has an associated interpolation filter that prescribes how to obtain a predicted coding value when proceeding in the direction defined by the intra-prediction mode. In accordance with the present principles, the interpolation filters defined by the H.264 can also provide a mechanism for estimating pixel values for error concealment purposes. As described in greater detail below, the H.264 interpolation filters can be used in their exact form for error concealment when error concealment proceeds in the decoding order. Alternatively, when the error concealment proceeds in a different order, a mirrored version of the H.264 interpolation filters has to be considered.

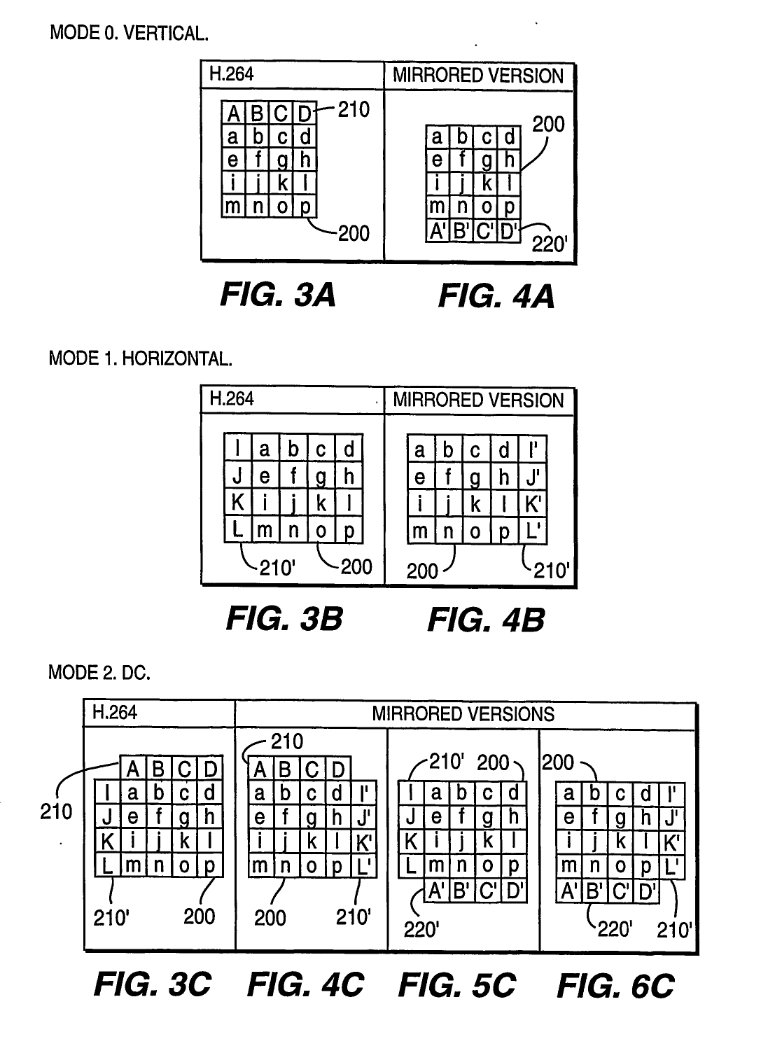

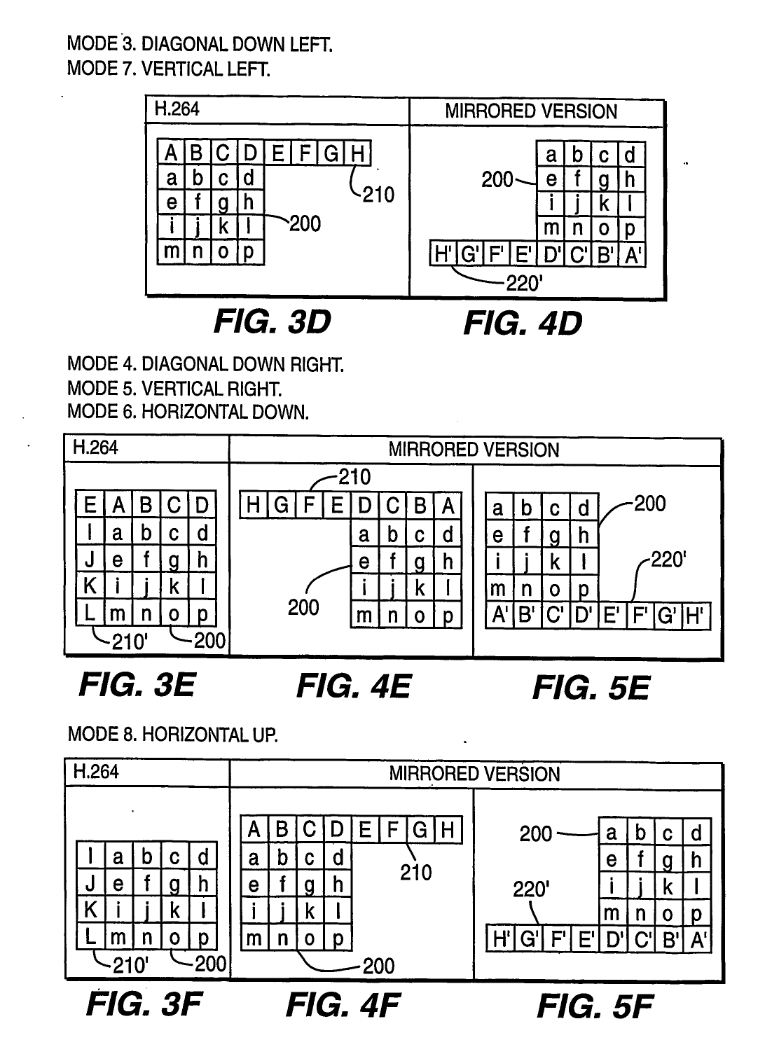

FIGS. 3A-3F each depict the position of the sets of reference pixels (A, B, C, D and I,J,K,L) used for the interpolation filters corresponding to the Intra 4×4 prediction modes illustrated in FIG. 2. (Note that in some instances, two different interpolation filters associated to two different intra-prediction modes may use the same set of reference pixels.) In each of FIGS. 3A-3F, there appears a sub-macroblock 200 having missing/corrupted pixels requiring concealment using values estimated from the pixel values within a neighboring row and/or column. For each intra-prediction mode, there exists one interpolation filter that prescribes exactly how to obtain an estimate for each missing/corrupted pixel in the sub-macroblock 200 from the neighboring pixel values.

To better understand the nature of each such interpolation filter, refer to FIG. 3A, which depicts error concealment for Mode 0 using the interpolation filter prescribed by the H.264 coding technique for that mode. Ordinarily, the interpolation filter prescribed by the H.264 coding technique defines the mechanism for obtaining coding prediction values. In accordance with the present principles, the interpolation filter prescribed by the H.264 coding technique also provides a mechanism for obtaining error concealment values. As seen in FIG. 3A, the 4×4 pixel sub-macroblock 200 contains pixels a-p each of which requires concealment. The values of the pixels A-D in a neighboring row of pixels 210, which lies above the upper row of pixels a-d in the sub-macroblock 200, provide values from which to estimate a concealment value for each of the pixels a-p using the H.264 coding technique interpolation filter associated with Mode 0. For Mode 0 (vertical), the value of the pixel A in row 210 provides a concealment estimate for each of the pixels a, e, i, and m in the first (left hand-most) column of the sub-macroblock 200 in accordance with the interpolation filter prescribed for Mode 0 by the H.264 coding technique. Likewise, the pixel B in row 210 provides a concealment estimate for each of the pixels b, f, j, and n in the second column. In a similar fashion, the pixels C and D in the row 210 each provide an estimate for the pixels in the third and fourth columns, respectively, in the sub-macroblock 200.

In some instances, one or more of the pixels A-D in row 210 may have missing values, and thus provide a poor estimate for the pixels a-p in the sub-macroblock 200. In accordance with another aspect of the present principles, a “mirrored” interpolation filter for Mode 1 serves to prescribe the manner in which to obtain such pixel concealment values. In contrast to the Mode 1 H.264 coding technique interpolation filter which makes use of the top neighboring row 210 to provide concealment values as seen in FIG. 3A, the mirrored interpolation filter of the present principles makes use of a bottom neighboring row 220 of pixels A′, B′, C′ and D′ for error concealment purposes as seen in FIG. 4A. Thus, instead of using value of pixel A in row 210 to estimate each of the pixels a, e, i and m, the mirrored interpolation filter employs the pixel A′ in row 220. Likewise, the pixels B′, C′ and D′ in row 220′ provide estimates for the concealment values for the pixels in second, third and fourth columns, respectively, of the sub-macroblock 200 using the mirrored interpolation filter for Mode 0.

Table 1 summarizes the H.264 coding technique interpolation filter and the mirrored interpolation filter for providing error concealment values for Mode 0.

TABLE 1
Mode 0 (Vertical)

| Sub | | |
|---|---|---|
| Macroblock 200 Pixels | H.264 in FIG. 3A | H.264 mirrored in FIG. 4A |
| a, e, i, m are equal to | A | A′ |
| b, f, j, n are equal to | B | B′ |
| c, g, k, o are equal to | C | C′ |
| d, h, l, p are equal to | D | D′ |

FIG. 3B depicts error concealment for Mode 1 using the Mode 1 interpolation filter prescribed by the H.264 coding technique. Each of the pixels I-Lin each row of a neighboring column 210′ to the left of the sub-macroblock 200 provides an error concealment estimate for each of the pixels in a corresponding row of the sub-macroblock. Thus, for example, the pixel I in the first (upper) row of the column 210 provides a concealment estimate for each of the pixels a, b, c, and d in the first (upper most) row of the sub-macroblock 200. Likewise, the pixel “J” in column 210′ provides a concealment estimate for the pixels e, f, g and h in the second row of the sub-macroblock 200. Similarly, the pixels K and L provide concealment estimates for the pixels in the third and fourth rows, respectively, of the sub-macroblock 200.

FIG. 4B depicts error concealment for Mode 1 using a mirrored interpolation filter. Rather than making use of the pixels I, J, K and L in the left-hand column 210′, the mirrored interpolation filer for Mode 1 makes use of the pixels I′, J′, K′ and L′ in a right hand neighboring column 220′ to provide estimates of the concealment values for the pixels in the first (top), second, third and fourth rows, respectively, of the sub-macroblock 200.

Table 2 summarizes the H.264 coding technique interpolation filter and the mirrored interpolation filter for estimating concealment values for Mode 1.

TABLE 2
Mode 1 (Horizontal)

| Sub | | |
|---|---|---|
| Macroblock 200 Pixels | H.264 in FIG. 3B | H.264 mirrored in FIG. 4B |
| a, b, c, d are equal to | I | I′ |
| e, f, g, h are equal to | J | J′ |
| i, j, k, l are equal to | K | K′ |
| m, n, o, p are equal to | L | L′ |

FIG. 3C depicts error concealment for the DC intra-prediction mode. As defined in the H.264 coding technique, the DC mode interpolation filter for coding prediction computes the average of the pixels (A+B+C+D+I+J+K+L+4)/8, whenever all these samples are available, where the pixels A, B, C and D lie in a neighboring row 210 above the sub-macroblock 200 and the pixels I, J, K and L lie in a neighboring column 210′ to the left of the sub-macroblock. In other words, all the pixels a-p inside the sub-macroblock 200 are predicted for coding purposes with the same value corresponding to the average of the neighboring pixel values of the column and row to the left and above, respectively, of the sub-macroblock. FIGS. 4C, 5C and 6C depict the mirrored versions of the set of reference pixels shown in FIG. 3C. These mirrored versions can be used for error concealment purposes when the block at the left and/or above the missing block is also corrupted.

Table 2 summarizes the H.264 coding technique interpolation filter and the mirrored interpolation filters for estimating concealment values for Mode 2.

TABLE 3
Mode 2 (DC)

| Sub Macroblock 200 Pixels | H.264 in FIG. 3C | H.264 mirrored in FIG. 4C | H.264 mirrored in FIG. 5C | H.264 mirrored in FIG. 6C |
|---|---|---|---|---|
| a, b, c, d, e, f, g, h, i, j, k, | (A + B + C + D + I + | (A + B + C + D + I′ + | (A′ + B′ + C′ + D′ + I + | (A′ + B′ + C′ + D′ + I′ + J′ + K′ + |
| l, m, n, o, p are equal to | J + K + L + 4)/8 | J′ + K′ + L′ + 4)/8 | J + K + L + 4)/8 | L′ + 4)/8 |

However, unlike the other intra-prediction modes, the DC intra-prediction mode interpolation filter prescribed by the H.264 coding technique doesn't provide a good prediction for error concealment purposes. The H.264 coding technique interpolation filter specified for the DC mode provides a very rough prediction that creates flat zones in the concealed image. For that reason, its use for error concealment purposes is recommended only for applications allowing low quality results. For the other applications, another type of interpolation filter, classically known as weighted interpolation, could serve to provide a better prediction for the error concealment values. When this technique applies to the DC mode, the estimated value of each pixel within the sub-macroblock 200 is obtained independently as the weighted sum of the nearest pixel values from a neighboring column and a neighboring row in the vertical and horizontal directions, respectively, that has been either correctly received or already concealed.

Classically, the following relationship prescribes the weighted interpolation of the pixel value at the (i,j) position:
Pixel(i,j)=W0*Pixel(i0−1,j)+W1*Pixel(i0,j0−1)

where W0 and W1 weigh the influence of the pixel values used as references. Typically, W0 and W1 each represent the distance between the missing pixel and its references. In the illustrated embodiment, W0=(i−i0) and W1=(j−j0). Using the same notation employed to describe the other interpolation filters defined by the H.264 coding technique, Tables 3A-D depict the weighted interpolation filters for the DC intra-prediction mode defined depending on which rows/columns of neighboring pixels are used as reference.

TABLE 3A
Mode 2 (DC) Weighted interpolation in FIG. 3C

a = (4A + 4I)/8
b = (4B + 3I)/7
c = (4C + 2I)/6
d = (4D + 1I)/5
e = (3A + 4J)/7
f = (3B + 3J)/6
g = (3C + 2J)/5
h = (3D + 1J)/4
i = (2A + 4K)/6
j = (2B + 3K)/5
k = (2C + 2K)/4
l = (2D + 1K)/3
m = (1A + 4L)/5
n = (1B + 3L)/4
o = (1C + 2L)/3
p = (1D + 1L)/2

TABLE 3B
Mode 2 (DC) Weighted interpolation in FIG. 4C

a = (4A + 1I′)/5
b = (4B + 2I′)/6
c = (4C + 3I′)/7
d = (4D + 4I′)/8
e = (3A + 1J′)/4
f = (3B + 2J′)/5
g = (3C + 3J′)/6
h = (3D + 4J′)/7
i = (2A + 1K′)/3
j = (2B + 2K′)/4
k = (2C + 3K′)/5
l = (2D + 4K′)/6
m = (1A + 1L′)/2
n = (1B + 2L′)/3
o = (1C + 3L′)/4
p = (1D + 4L′)/5

TABLE 3C
Mode 2 (DC) Weighted interpolation in FIG. 5C

a = (1A′ + 4I)/5
b = (1B′ + 3I)/4
c = (1C′ + 2I)/3
d = (1D′ + 1I)/2
e = (2A′ + 4J)/6
f = (2B′ + 3J)/5
g = (2C′ + 2J)/4
h = (2D′ + 1J)/3
i = (3A′ + 4K)/7
j = (3B′ + 3K)/6
k = (3C′ + 2K)/5
l = (3D′ + 1K)/4
m = (4A′ + 4L)/8
n = (4B′ + 3L)/7
o = (4C′ + 2L)/6
p = (4D′ + 1L)/5

TABLE 3D
Mode 2 (DC) Weighted interpolation in FIG. 6C

a = (1A′ + 1I′)/2
b = (1B′ + 2I′)/3
c = (1C′ + 3I′)/4
d = (1D′ + 4I′)/5
e = (2A′ + 1J′)/3
f = (2B′ + 2J′)/4
g = (2C′ + 3J′)/5
h = (2D′ + 4J′)/6
i = (3A′ + 1K′)/4
j = (3B′ + 2K′)/5
k = (3C′ + 3K′)/6
l = (3D′ + 4K′)/7
m = (4A′ + 1L′)/5
n = (4B′ + 2L′)/6
o = (4C′ + 3L′)/7
p = (4D′ + 4L′)/8

FIG. 3D depicts the position of the set of reference pixels to be used for error concealment for both Mode 3 (diagonal down left) and Mode 7 (vertical left) using the H.264 coding technique interpolation filter. For each of Modes 3 and 7, the corresponding interpolation filter prescribed by the H.264 coding technique makes use of a separate use weighted average of the pixels A, B. C, D, E, F, and G in a neighboring row 210 above the sub-macroblock 200. Similarly, FIG. 4D depicts the position of the set of reference pixels to be used for error concealment using a mirrored interpolation filters for both Mode 3 (diagonal down left) and Mode 7 (vertical left). For each of Modes 3 and 7, the corresponding mirrored interpolation filter makes use of a separate weighted average of the pixels H′ G′, F′ E′ D′ C′ B′ and A′ in an extended row neighboring row 210′ lying below the sub-macroblock 200.

Table 4 summarizes the H.264 coding technique interpolation filter and the mirrored interpolation filter for providing error concealment values for Mode 3.

TABLE 4
Mode 3 (Diagonal down-left)

| Sub | | |
|---|---|---|
| Macroblock 200 Pixels | H.264 in FIG. 3D | H.264 mirrored in FIG. 4D |
| a is equal to | (A + 2B + C + 2)/4 | (G′ + 3H′ + 2)/4 |
| b, e are equal to | (B + 2C + D + 2)/4 | (F′ + 2G′+ H′ + 2)/4 |
| c, f, i are equal to | (C + 2D + E + 2)/4 | (E′ + 2F′ + G′ + 2)/4 |
| d, g, j, m are equal to | (D + 2E + F + 2)/4 | (D′ + 2E′ + F′ + 2)/4 |
| h, k, n are equal to | (E + 2F + G + 2)/4 | (C′ + 2D′ + E′ + 2)/4 |
| l, o are equal to | (F + 2G + H + 2)/4 | (B′ + 2C′ + D′ + 2)/4 |
| p is equal to | (G + 3H + 2)/4 | (A′ + 2B′ + C′ + 2)/4 |

By way of example, the interpolation filter prescribed by the H.264 coding technique for predicting coding values, and utilized in accordance with the present principles for estimating error concealment values, provides that pixel a in the sub-macroblock 200 can be estimated from the values of the pixels A, B and C using the relationship (A+2B+C+2)/4 where the pixels A, B and C each lie in the neighboring row 210 above the sub-macroblock 200. Similarly, the mirrored interpolation filter for Mode 3 provides an error concealment estimate for pixel a in the sub-macroblock 200 from the values of the pixels G′ and H′ in accordance with the relationship (G′+3H′+2)/4. The remaining pixels b-p can likewise be estimated for error concealment purposes in accordance with the relationship set forth in Table 4.

Table 5 summarizes the H.264 coding technique interpolation filter and the mirrored interpolation filter for providing error concealment values for Mode 7

TABLE 5
Mode 7. (Vertical left)

| Sub | | |
|---|---|---|
| Macroblock 200 Pixels | H.264 in FIG. 3D | H.264 mirrored in FIG. 4D |
| a is equal to | (A + B + 1)/2 | (E′ + 2F′ + G′ + 2)/4 |
| b, i are equal to | (B + C + 1)/2 | (D′ + 2E′ + F′ + 2)/4 |
| c, j are equal to | (C + D + 1)/2 | (C′ + 2D′ + E′ + 2)/4 |
| d, k are equal to | (D + E + 1)/2 | (B′ + 2C′ + D′ + 2)/4 |
| e is equal to | (A + 2B + C + 2)/4 | (E′ + F′ + 1)/2 |
| f, m are equal to | (B + 2C + D + 2)/4 | (D′ + E′ + 1)/2 |
| g, n are equal to | (C + 2D + E + 2)/4 | (C′ + D′ + 1)/2 |
| h, o are equal to | (D + 2E + F + 2)/4 | (B′ + C′ + 1)/2 |
| l is equal to | (E + F + 1)/2 | (A′ + 2B′ + C′ + 2)/4 |
| p is equal to | (E + 2F + G + 2)/4 | (A′ + B′ + 1)/2 |

FIG. 3E depicts the position of the set of reference pixels to be used for error concealment for Modes 4 (diagonal Down Right), Mode 5 (Vertical Right) and Mode 6 (Horizontal Down) using the interpolation filter prescribed by the H.264 coding technique. Because these interpolation filters are defined to require reference pixels on both the left neighboring column and the above neighboring column, their mirroring for error concealment purposes would require the definition of four different cases as for the DC mode. To reduce the number of cases, we propose an alternative definition avoiding to use reference pixels from the left column. FIG. 4E depicts the position of the set of reference pixels to be used for error concealment for Modes 4, 5 and 6 using a

mirrored version of the previous interpolation filters. The filter in FIG. 4E is an alternative to the filter in FIG. 3E as defined by the H.264 video compression standard. The other mirrored interpolation filter in FIG. 5E is required to allow the error concealment to proceed out of the decoding order. Although different mirroring procedures could be considered, the one proposed in this embodiment locates all the reference pixels in only one neighboring row or only one neighboring column. Such mirroring has two main advantages: first, it facilitates the memory access; second, it reduces the number of cases for which the filter has to be specified. [Note: this applies to all the mirrored interpolated filters defined in this invention] Table 6 summarizes the H.264 coding technique interpolation filter and the mirrored interpolation filter for providing error concealment values for Mode 4.

TABLE 6
Mode 4. Diagonal down-right.

| Sub Macroblock 200 | | H.264 mirrored in | H.264 mirrored in |
|---|---|---|---|
| Pixels | H.264 in FIG. 3E | | |
| d is equal to | (B + 2C + D + 2)/4 | (A + 2B + C + 2)/4 | (G′ + 3H′ + 2)/4 |
| c, h are equal to | (A + 2B + C + 2)/4 | (B + 2C + D + 2)/4 | (F′ + 2G′ + H′ + 2)/4 |
| b, g, l are equal to | (Q + 2A + B + 2)/4 | (C + 2D + E + 2)/4 | (E′ + 2F′+ G′ + 2)/4 |
| a, f, k, p are equal to | (A + 2Q + I + 2)/4 | (D + 2E + F + 2)/4 | (D′ + 2E′ + F′ + 2)/4 |
| e, j, o are equal to | (Q + 2I + J + 2)/4 | (E + 2F + G + 2)/4 | (C′ + 2D′ + E′ + 2)/4 |
| i, n are equal to | (I + 2J + K + 2)/4 | (F + 2G + H + 2)/4 | (B′ + 2C′ + D′ + 2)/4 |
| m is equal to | (J + 2K + L)/4 | (G + 3H + 2)/4 | (A′ + 2B′ + C′ + 2)/4 |

Table 7 summarizes the H.264 coding technique interpolation filter and the mirrored interpolation filter for providing error concealment values for Mode 5.

TABLE 7
Mode 5. Vertical right.

| Sub Macroblock 200 | | H.264 mirrored in | H.264 mirrored in |
|---|---|---|---|
| Pixels | H.264 in FIG. 3F | | |
| a, j are equal to | (E + A + 1)/2 | (D + E + 1)/2 | (B′ + 2C′ + D′ + 2)/4 |
| b, k are equal to | (A + B + 1)/2 | (C + D + 1)/2 | (C′ + 2D′ + E′ + 2)/4 |
| c, l are equal to | (B + C + 1)/2 | (B + C + 1)/2 | (D′ + 2E′ + F′ + 2)/4 |
| d is equal to | (C + D + 1)/2 | (A + B + 1)/2 | (E′ + 2F′ + G′ + 2)/4 |
| e, n are equal to | (I + 2E + A + 2)/4 | (D + 2E + F + 2)/4 | (B′ + C′ + 1)/2 |
| f, o are equal to | (E + 2A + B + 2)/4 | (C + 2D + E + 2)/4 | (C′ + D′ + 1)/2 |
| g, p are equal to | (A + 2B + C + 2)/4 | (B + 2C + D + 2)/4 | (D′ + E′ + 1)/2 |
| h is equal to | (B + 2C + D + 2)/4 | (A + 2B + C + 2)/4 | (E′ + 2F′ + G + 1)/4 |
| i is equal to | (E + 2I + J + 1)/4 | (E + 2F + G + 1)/4 | (A′ + 2B′ + C′ + 2)/4 |
| m is equal to | (I + 2J + K + 2)/4 | (F + 2G + H + 2)/4 | (A′ + B′ + 1)/2 |

Table 8 summarizes the H.264 coding technique interpolation filter and the mirrored interpolation filter for providing error concealment values for Mode 6.

TABLE 8
Mode 6. Horizontal down.

| Sub Macroblock 200 | | H.264 mirrored in | H.264 mirrored in |
|---|---|---|---|
| Pixels | H.264 in FIG. 3E | | |
| a, g are equal to | (E + I + 1)/2 | (E + F + 1)/2 | (F′ + 2G′ + H′ + 2)/4 |
| b, h are equal to | (I + 2E + A + 2)/4 | (F + 2E + D + 2)/4 | (G′ + H′ + 1)/2 |
| c is equal to | (E + 2A + B + 2)/4 | (E + 2D + C + 2)/4 | H′ |
| d is equal to | (A + 2B + C + 2)/4 | (D + 2C + B + 2)/4 | H′ |
| e, k are equal to | (I + J + 1)/2 | (F + G + 1)/2 | (E′ + 2F′ + G′ + 2)/4 |
| f, l are equal to | (E + 2I + J + 2)/4 | (E + 2F + G + 2)/4 | (F′ + G′ + 1)/2 |
| i, o are equal to | (J + K + 1)/2 | (G + H + 1)/2 | (F′ + 2E′ + D′ + 2)/4 |
| j, p are equal to | (I + 2J + K + 2)/4 | (F + 2G + H + 2)/4 | (E′ + F′ + 1)/2 |
| m is equal to | (K + L + 1)/2 | H | (D′ + 2C′ + B′ + 2)/4 |
| n is equal to | (J + 2K + L + 2)/4 | H | (E′ + 2D′ + C′ + 2)/4 |

FIG. 3F depicts error concealment for Mode 8 (Horizontal Up) using the interpolation filter prescribed by the H.264 coding technique. FIGS. 4E and 5E depict error concealment for Mode 8 using two mirrored interpolation filter. As for the Modes 4, 5, and 6, the definition of the mirrored filter in FIG. 4F is proposed as an alternative to the H.264 interpolation filter with the previously mentioned advantages. Table 9 summarizes the H.264 coding technique interpolation filter and the mirrored interpolation filter for providing error concealment values for Mode 8.

TABLE 9
Mode 8 (Horizontal up)

| Sub Macroblock 200 | | H.264 mirrored in | H.264 mirrored in |
|---|---|---|---|
| Pixels | H.264 in FIG. 3F | | |
| a is equal to | (I + J + 1)/4 | (D + 2C + B + 2)/4 | H′ |
| b is equal to | (I + 2J + K + 2)/4 | (E + 2D + C + 2)/4 | H′ |
| c, e are equal to | (J + K + 1)/2 | (F + 2E + D + 2)/4 | (G′ + H′ + 1)/2 |
| d, f are equal to | (J + 2K + L + 2)/4 | (E + F + 1)/2 | (F′ + 2G′ + H′ + 2)/4 |
| g, i is equal to | (K + L + 1)/2 | (E + 2F + G + 2)/4 | (F′ + G′ + 1)/2 |
| h, j are equal to | (K + 2L + L + 1)/4 | (F + G + 1)/2 | (E′ + 2F′ + G′ + 2)/4 |
| k, m are equal to | L | (F + 2G + H + 2)/4 | (E′ + F′ + 1)/2 |
| l, n are equal to | L | (G + H + 1)/2 | (F′ + 2E′ + D′ + 2)/4 |
| o is equal to | L | H | (E′ + 2D′ + C′ + 2)/4 |
| p is equal to | L | H | (D′ + 2C′ + B′ + 2)/4 |

The foregoing describes a technique for defining directional interpolation filters that establish the mechanism by which to conceal of errors within a coded video stream.

1. A method for concealing errors in a coded image formed of an array of macroblocks, comprising the steps of:
identifying macroblocks within the array having missing/corrupted pixel values;
deriving at least one intra-prediction mode for each identified macroblock to define a concealment direction, the at least one intra-prediction mode derived in accordance with the coded image;
establishing an interpolation filter for the identified intra-prediction mode for estimating concealment values for each identified macroblock along the concealment direction; and
concealing the identified macroblock in accordance with the estimated concealment values.

2. The method according to claim 1 wherein the image is coded in accordance with the H.264 coding technique and wherein the step of deriving the at least one intra-prediction mode further comprises the step of deriving an Intra_{—}4×4 prediction mode prescribed by the H.264 coding technique.

3. The method according to claim 2 wherein the step of establishing the interpolation filter further comprises selecting the interpolation filter prescribed by the H.264 coding technique for the derived Intra_{—}4×4 prediction mode.

4. The method according to claim 2 wherein the step of establishing the interpolation filter further comprises the step of deriving a interpolation filter mirroring the interpolation filter prescribed by the H.264 coding technique for the derived Intra_{—}4×4 prediction mode.

5. The method according to claim 2 wherein the derived Intra_{—}4×4 prediction mode comprises Mode 0 (vertical) and wherein the derived interpolation filter comprises the interpolation filter prescribed by the H.264 coding technique for Mode 0.

6. The method according to claim 4 wherein the derived Intra_{—}4×4 prediction mode comprises Mode 1 (horizontal) and wherein the derived interpolation filter comprises the interpolation filter prescribed by the H.264 coding technique for Mode 1.

7. The method according to claim 2 wherein the derived Intra_{—}4×4 prediction mode comprises Mode 2 (DC) and wherein the step of establishing the interpolation filter further comprises the step independently weighting a sum of pixel values from a neighboring column and a neighboring row in a vertical direction and a horizontal direction, respectively.

8. The method according to claim 4 wherein the derived Intra_{—}4×4 prediction mode comprises Mode 3 (Diagonal down left) and wherein the derived interpolation filter comprises the interpolation filter prescribed by the H.264 coding technique for Mode 3.

9. The method according to claim 4 wherein the derived Intra_{—}4×4 prediction mode comprises Mode 7 (vertical left) and wherein the derived interpolation filter comprises the interpolation filter prescribed by the H.264 coding technique for Mode 7.

10. The method according to claim 4 wherein the derived Intra_{—}4×4 prediction mode comprises Mode 47 (diagonal down right) and wherein the derived interpolation filter comprises the interpolation filter prescribed by the H.264 coding technique for Mode 4.

11. The method according to claim 4 wherein the derived Intra_{—}4×4 prediction mode comprises Mode 5 (Vertical right) and wherein the derived interpolation filter comprises the interpolation filter prescribed by the H.264 coding technique for Mode 5.

12. The method according to claim 4 wherein the derived Intra_{—}4×4 prediction mode comprises Mode 6 (horizontal down) and wherein the derived interpolation filter comprises the interpolation filter prescribed by the H.264 coding technique for Mode 6.

13. The method according to claim 4 wherein the derived Intra_{—}4×4 prediction mode comprises Mode 8 (horizontal up) and wherein the derived interpolation filter comprises the interpolation filter prescribed by the H.264 coding technique for Mode 8.

14. A method for concealing errors in a coded image comprised of an array of macroblocks, the image coded in accordance with the H.264 coding technique, the method, comprising the steps of:
identifying macroblocks within the array having missing/corrupted pixel values;
deriving at least one Intra_{—}4×4 prediction mode in accordance with the H.264 coding technique for each identified macroblock to define a concealment direction;
establishing an interpolation filter for the identified intra-prediction mode for estimating concealment values for each identified macroblock along the concealment direction; and
concealing the identified macroblock in accordance with the estimated concealment values.

15. The method according to claim 14 wherein the step of establishing the interpolation filter further comprises selecting the interpolation filter prescribed by the H.264 coding technique for the derived Intra_{—}4×4 prediction mode.

16. The method according to claim 14 wherein the step of establishing the interpolation filter further comprises the step of deriving a interpolation filter mirroring the interpolation filter prescribed by the H.264 coding technique for the derived Intra_{—}4×4 prediction mode.

17. The method according to claim 14 wherein the derived Intra_{—}4×4 prediction mode comprises Mode 1 (horizontal) and wherein the derived interpolation filter comprises the interpolation filter prescribed by the H.264 coding technique for Mode 1.

18. The method according to claim 14 wherein the derived Intra_{—}4×4 prediction mode comprises Mode 3 (Diagonal down left) and wherein the derived interpolation filter comprises the interpolation filter prescribed by the H.264 coding technique for Mode 3.

19. The method according to claim 14 wherein the derived Intra_{—}4×4 prediction mode comprises Mode 7 (vertical left) and wherein the derived interpolation filter comprises the interpolation filter prescribed by the H.264 coding technique for Mode 7.

20. The method according to claim 14 wherein the derived Intra_{—}4×4 prediction mode comprises Mode 4 (Diagonal down right) and wherein the derived interpolation filter comprises the interpolation filter prescribed by the H.264 coding technique for Mode 4

21. The method according to claim 14 wherein the derived Intra_{—}4×4 prediction mode comprises Mode 5 (Vertical right) and wherein the derived interpolation filter comprises the interpolation filter prescribed by the H.264 coding technique for Mode 5.

22. The method according to claim 14 wherein the derived Intra_{—}4×4 prediction mode comprises Mode 6 (horizontal down) and wherein the derived interpolation filter comprises the interpolation filter prescribed by the H.264 coding technique for Mode 6.

23. The method according to claim 14 wherein the derived Intra_{—}4×4 prediction mode comprises Mode 8 (horizontal up) and wherein the derived interpolation filter comprises the interpolation filter prescribed by the H.264 coding technique for Mode 8.
